(19) United States
(12) Patent Application Publication
(10) Pub. No.: US 2025/0259139 A1
(43) Pub. Date: Aug. 14, 2025

(54) SYSTEMS AND METHODS FOR SUPPLY CHAIN MODELING AND PREDICTION

(71) Applicant: Walmart Apollo, LLC, Bentonville, AR (US)

(72) Inventors: Nitin Kishore Sai Samala, Telangana (IN); Shantala Narasimhamurthy Manchenahally, Bengaluru, Karnataka (IN); Ankit Ajit Jain, Bangalore, Karnataka (IN); Prakhar Mehrotra, Saratoga, CA (US)

(21) Appl. No.: 18/437,616

(22) Filed: Feb. 9, 2024

(51) Int. Cl. G06Q 10/083; G06Q 10/067

(52) U.S. Cl. CPC G06Q 10/0838; G06Q 10/067

(57) ABSTRACT

Systems and methods for supply chain network modeling and performance prediction are disclosed. In some embodiments, a disclosed method includes: receiving, from a computing device, a query associated with a supply chain network; representing the supply chain network as at least one graph based on historical transactions in the supply chain network; obtaining at least one machine learning model that is trained based on graph data related to nodes and edges in the at least one graph; generating, using the at least one machine learning model, supply chain prediction data based on the query; and transmitting the supply chain prediction data to the computing device.

### TECHNICAL FIELD

This application relates generally to supply chain optimization and, more particularly, to systems and methods for modeling a supply chain network and predicting performances of the supply chain network based on the modeling.

### BACKGROUND

A supply chain plays a critical role in ensuring an efficient flow of goods and services from manufacturers to end consumers. However, managing a complex and dynamic supply chain network poses numerous challenges, including optimizing operations, minimizing disruptions, scaling, and improving operation efficiency overall performance.

Supply chain operations and tasks were typically solved independently, focusing only on a very specific aspect of the supply chain. There is no accurate way to simulate and predict performance of the entire supply chain, especially for the scale and complexity of the supply chain of a big retail corporation. Existing simulation tools are all limited to some specific sub tasks in supply chain operations, are not adaptive to real-time data and lack the ability to capture the dynamic nature of supply chain operations.

### SUMMARY

The embodiments described herein are directed to systems and methods for supply chain network modeling and performance prediction.

In various embodiments, a system including a non-transitory memory configured to store instructions thereon and at least one processor is disclosed. The at least one processor is operatively coupled to the non-transitory memory and configured to read the instructions to: receive, from a computing device, a query associated with a supply chain network; represent the supply chain network as at least one graph based on historical transactions in the supply chain network; obtain at least one machine learning model that is trained based on graph data related to nodes and edges in the at least one graph; generate, using the at least one machine learning model, supply chain prediction data based on the query; and transmit the supply chain prediction data to the computing device.

In various embodiments, a computer-implemented method is disclosed. The computer-implemented method includes: receiving, from a computing device, a query associated with a supply chain network; representing the supply chain network as at least one graph based on historical transactions in the supply chain network; obtaining at least one machine learning model that is trained based on graph data related to nodes and edges in the at least one graph; generating, using the at least one machine learning model, supply chain prediction data based on the query; and transmitting the supply chain prediction data to the computing device.

In various embodiments, a non-transitory computer readable medium having instructions stored thereon is disclosed. The instructions, when executed by at least one processor, cause at least one device to perform operations including: receiving, from a computing device, a query associated with a supply chain network; representing the supply chain network as at least one graph based on historical transactions in the supply chain network; obtaining at least one machine learning model that is trained based on graph data related to nodes and edges in the at least one graph; generating, using the at least one machine learning model, supply chain prediction data based on the query; and transmitting the supply chain prediction data to the computing device.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for supply chain network modeling and performance prediction, in accordance with some embodiments of the present teaching;

FIG. 2 is a block diagram of a prediction data computing device, in accordance with some embodiments of the present teaching;

FIG. 3 is a block diagram illustrating various portions of a system for supply chain network modeling and performance prediction, in accordance with some embodiments of the present teaching;

FIG. 4 illustrates an exemplary process for modeling a supply chain network, in accordance with some embodiments of the present teaching;

FIG. 5 illustrates an exemplary daily heterogenous graph, in accordance with some embodiments of the present teaching;

FIG. 6 illustrates an exemplary process for training and optimizing a graph neural network, in accordance with some embodiments of the present teaching;

FIG. 7 illustrates an exemplary task pipeline in a supply chain network, in accordance with some embodiments of the present teaching;

FIG. 8 illustrates an exemplary simulation framework for a supply chain network, in accordance with some embodiments of the present teaching;

FIG. 9 is a flowchart illustrating an exemplary method for supply chain network modeling and performance prediction, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

When digital twins are used for supply chain management, they may have limitations in data integration and quality, computational complexity, limited predictive power and the complete lack of standardization, calibration, and validation. One objective of various embodiments in the present teaching is to develop a digital twin of a supply chain network using heterogenous graph neural networks to perform simulated optimization by means of surrogate modeling. Graph neural networks can learn and model snapshots of the daily network topology and express the latent relationships between different entities involved in the transactions in the supply chain network.

The disclosed systems and methods can enhance decision-making capabilities in supply chain management, while reducing the complexity of modeling and simulating supply chain operations using heterogenous data sources. In some embodiments, the system creates a comprehensive virtual representation of the entire supply chain network, encompassing various interconnected entities, such as suppliers, manufacturers, distributors, stores, products and customers. The system can use surrogate modeling to build the digital twin to predict the outcomes of interest which cannot be measured or computed directly without incurring risks and costs associated with the changes in the real world. By leveraging graph neural networks, the digital twin can be used to simulate supply chain operations, analyze performance, and conduct counterfactual simulations to identify optimal strategies.

The digital twin of the supply chain built using heterogenous graph neural networks enables a range of valuable capabilities. First, the digital twin can simulate various supply chain scenarios, allowing decision-makers to understand the impact of different factors, such as changes in demand, disruptions in the network, or modifications to operational parameters. These simulations provide a risk-free environment to test and optimize strategies, leading to improved efficiency and resilience. Second, the digital twin can perform counterfactual simulations, exploring “what if” scenarios that diverge from the actual historical data. By manipulating variables and constraints within the model, decision-makers can explore alternative courses of action and evaluate their potential outcomes. This ability to experiment with different strategies without affecting the real-world operations is particularly valuable for supply chain optimization and risk management. Third, the digital twin can support real-time decision-making by integrating with data feeds from various sources, such as IoT sensors, transaction records, and market indicators. By continuously updating its state, the digital twin can provide up-to-date insights and recommendations, enabling proactive decision-making and prompt response to emerging challenges. This capability enhances agility and adaptability in supply chain management, crucial in a fast-paced and volatile business environment nowadays.

The novel method of building a digital twin of the supply chain using heterogenous graph neural networks (GNNs) represents a significant step towards transforming supply chain management, and has the potential to revolutionize supply chain operations, improving efficiency, resilience, and ultimately delivering better value to businesses and consumers. The digital twin of the supply chain provides a holistic view of the entire network, capturing both the structural and dynamic aspects of the system. By integrating real-time data feeds, the digital twin can continuously update its state and provide insights for decision-making. The supply chain network comprises diverse entities, each with its unique characteristics, relationships, and data formats.

GNN has an inductive nature of graph inference and the ability to encapsulate and account for latent relationships between nodes for each data point, allowing for predictions in historically unseen scenarios. In some embodiments, multiple GNN models work in conjunction with each other and connect end to end, allowing a more framework-wide optimization rather than merely individual task modelling. In some embodiments, multiple regional graphs that are trained for a particular task can be joined together to form a national graph.

Furthermore, in the following, various embodiments are described with respect to systems and methods for supply chain network modeling and performance prediction are disclosed. In some embodiments, a disclosed method includes: receiving, from a computing device, a query associated with a supply chain network; representing the supply chain network as at least one graph based on historical transactions in the supply chain network; obtaining at least one machine learning model that is trained based on graph data related to nodes and edges in the at least one graph; generating, using the at least one machine learning model, supply chain prediction data based on the query; and transmitting the supply chain prediction data to the computing device.

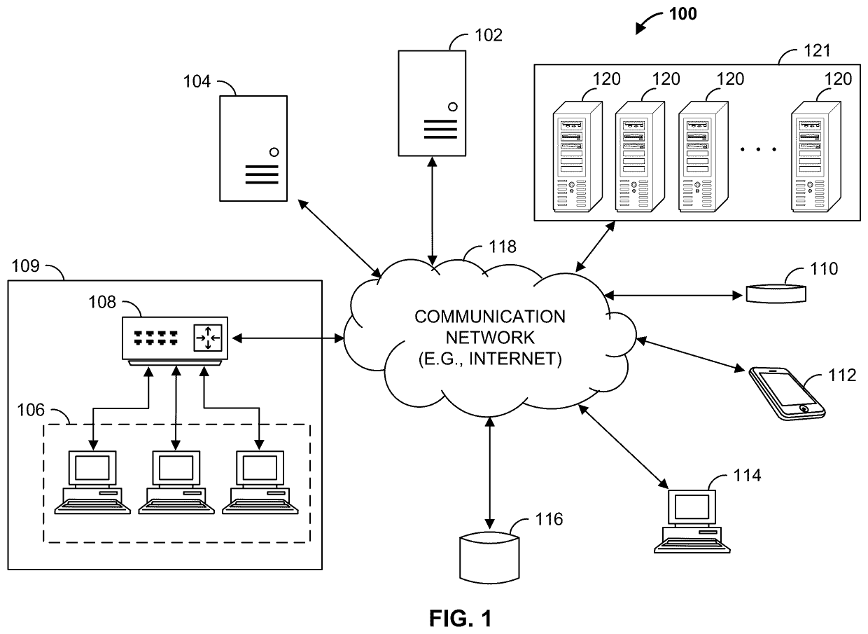

Turning to the drawings, FIG. 1 is a network environment 100 configured for supply chain network modeling and performance prediction, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a prediction data computing device 102, a server 104 (e.g., a web server or an application server), a cloud-based engine 121 including one or more processing devices 120, workstation(s) 106, a database 116, and one or more user computing devices 110, 112, 114 operatively coupled over the network 118. The prediction data computing device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the prediction data computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the prediction data computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the prediction data computing device 102, the processing devices 120, and/or the server 104 are operated by a retailer, and the multiple user computing devices 110, 112, 114 are operated by customers, advertisers, associates or managers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the prediction data computing device 102 over the communication network 118. The workstation(s) 106 may send data to, and receive data from, the prediction data computing device 102. For example, the workstation(s) 106 may transmit data identifying items purchased by a customer at the store 109 to the prediction data computing device 102. The workstation(s) 106 may also transmit other data related to the store 109 to the prediction data computing device 102.

Although FIG. 1 illustrates three user computing devices 110, 112, 114, the network environment 100 can include any number of user computing devices 110, 112, 114. Similarly, the network environment 100 can include any number of the prediction data computing devices 102, the processing devices 120, the workstations 106, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, each of the multiple user computing devices 110, 112, 114 may be operable to view, access, and interact with a website, such as a retailer's website, hosted by the server 104. The server 104 may transmit user session data related to a customer's activity (e.g., interactions) on the website. For example, a customer may operate one of the user computing devices 110, 112, 114 to initiate a web browser that is directed to the website hosted by the server 104. The customer may, via the web browser, search for items, view item advertisements for items displayed on the website, and click on item advertisements and/or items in the search result, for example. The website may capture these activities as user session data, and transmit the user session data to the prediction data computing device 102 over the communication network 118. The website may also allow the operator to add one or more of the items to an online shopping cart, and allow the customer to perform a “checkout” of the shopping cart to purchase the items. In some examples, the server 104 transmits purchase data identifying items the customer has purchased from the website to the prediction data computing device 102.

In some examples, the server 104 transmits a query associated with a supply chain network of a retailer to the prediction data computing device 102. The query may be sent standalone or together with historical transaction data on the supply chain network. In some examples, the query may carry or indicate a hypothetical scenario of the supply chain network.

In some examples, the prediction data computing device 102 may execute one or more models (e.g., programs or algorithms), such as a machine learning model, deep learning model, statistical model, etc., to generate supply chain prediction data. The prediction data computing device 102 may represent the supply chain network as at least one graph based on historical transaction data in the supply chain network. The prediction data computing device 102 may obtain a machine learning model (e.g. a graph neural network) that is trained based on graph data related to nodes and edges in the at least one graph, and generate, using the graph neural network, supply chain prediction data based on the query. The prediction data computing device 102 may then transmit the supply chain prediction data to the server 104 to predict a performance of the supply chain network in the hypothetical scenario indicated by the query. The prediction data computing device 102 may also identify and transmit root causes of the predicted performance of the supply chain network to the server 104 for further insight analysis and/or business decisions.

In some embodiments, the prediction data computing device 102 is further operable to communicate with the database 116 over the communication network 118. For example, the prediction data computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the prediction data computing device 102, in some examples, the database 116 can be a local storage device, such as a hard drive, a non-volatile memory, or a USB stick. The prediction data computing device 102 may store online purchase data received from the server 104 in the database 116. The prediction data computing device 102 may receive in-store purchase data and store related data from the store 109 and store them in the database 116. The prediction data computing device 102 may also receive from the server 104 user session data identifying events associated with browsing sessions, and may store the user session data in the database 116.

In some examples, the prediction data computing device 102 generates and/or updates different models (e.g., machine learning models, deep learning models, statistical models, algorithms, etc.) for supply chain network modeling and performance prediction. The prediction data computing device 102 may generate training data for the models based on historical user session data, purchase data, supply chain data, and/or simulated label data. The prediction data computing device 102 trains the models based on their corresponding training data, and stores the models in a database, such as in the database 116 (e.g., a cloud storage). The models, when executed by the prediction data computing device 102, allow the prediction data computing device 102 to generate supply chain predictions.

In some examples, the prediction data computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the prediction data computing device 102 may generate supply chain prediction data.

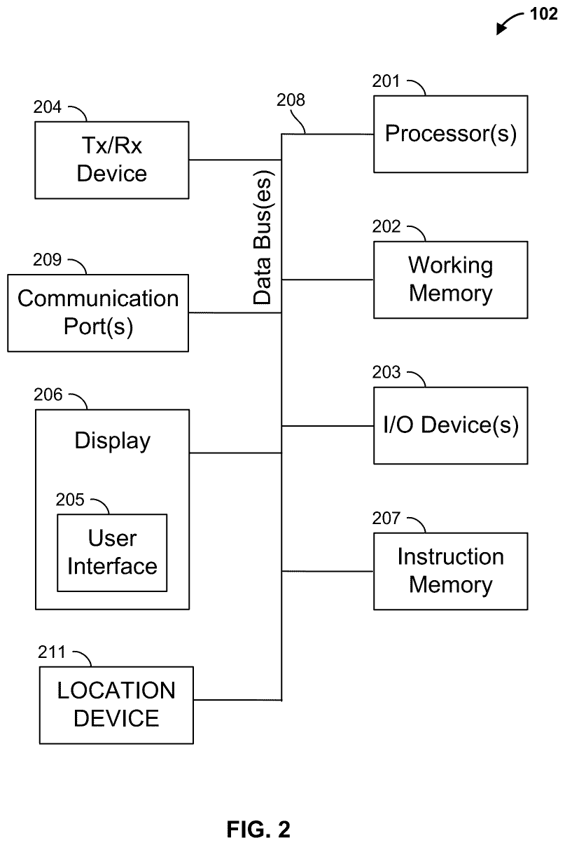

FIG. 2 illustrates a block diagram of a prediction data computing device, e.g. the prediction data computing device 102 of FIG. 1, in accordance with some embodiments of the present teaching. In some embodiments, each of the prediction data computing device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the prediction data computing device 102 can be combined, omitted, and/or replicated. In addition, it will be appreciated that additional elements other than those illustrated in FIG. 2 can be added to the prediction data computing device 102.

As shown in FIG. 2, the prediction data computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the prediction data computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the prediction data computing device 102 can include a single memory unit configured to operate as both instruction memory and working memory. Further, although embodiments are discussed herein including non-volatile memory, it will be appreciated that the prediction data computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the prediction data computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the prediction data computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the prediction data computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the prediction data computing device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the prediction data computing device 102 may determine a local geographical area (e.g., town, city, state, etc.) of its position.

In some embodiments, the prediction data computing device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

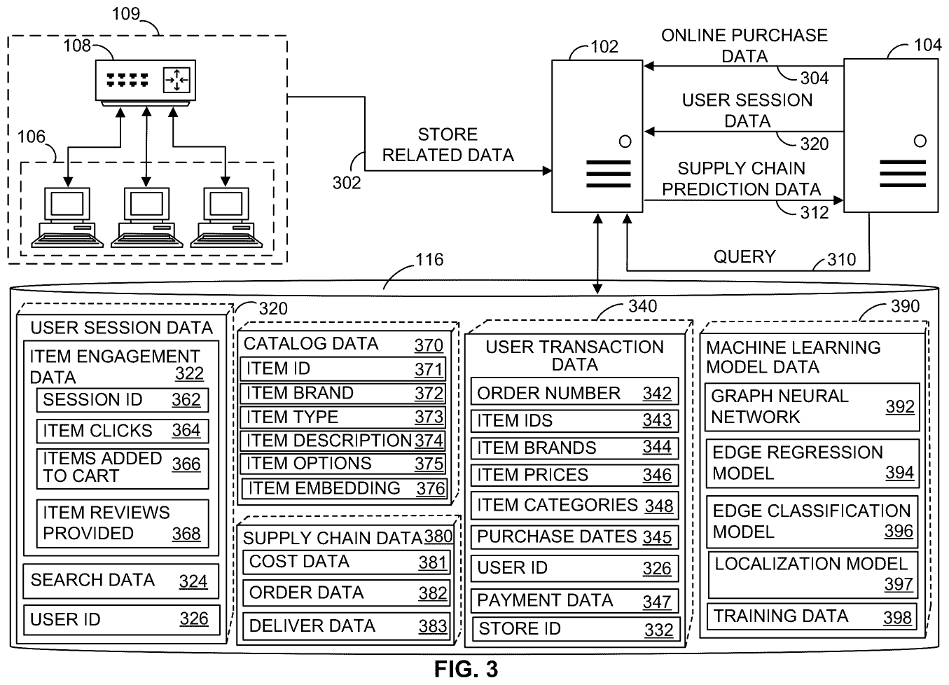

FIG. 3 is a block diagram illustrating various portions of a system for supply chain network modeling and performance prediction, e.g. the system shown in the network environment 100 of FIG. 1, in accordance with some embodiments of the present teaching. As indicated in FIG. 3, the prediction data computing device 102 may receive user session data 320 from the server 104, and store the user session data 320 in the database 116. The user session data 320 may identify, for each user (e.g., customer), data related to that user's browsing session, such as when browsing a retailer's webpage hosted by the server 104.

In some examples, the user session data 320 may include item engagement data 322, search data 324, and user ID 326 (e.g., a customer ID, retailer website login ID, a cookie ID, etc.). The item engagement data 322 may include one or more of a session ID 362 (i.e., a website browsing session identifier), item clicks 364 identifying items which a user clicked, items added-to-cart 366 identifying items added to the user's online shopping cart, and item reviews provided 368 identifying item reviews a user provided on the website. The search data 324 may identify one or more searches conducted by a user during a browsing session (e.g., a current browsing session).

The prediction data computing device 102 may also receive online purchase data 304 from the server 104, which identifies and characterizes one or more online purchases, such as purchases made by the user and other users via a retailer's website hosted by the server 104. The prediction data computing device 102 may also receive store related data 302 from the store 109, which identifies and characterizes one or more in-store purchases. In some embodiments, the store related data 302 may also indicate other information about the store 109.

The prediction data computing device 102 may parse the store related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding online orders, and store ID 332 for the corresponding in-store purchase, or for the pickup store or shipping-from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), item options 375 (e.g., item colors, sizes, flavors, etc.), and item embedding 376 representing the item in a vector space.

The database 116 may also store supply chain data 380, which may identify data of a supply chain network of a retailer associated with the prediction data computing device 102 and/or the server 104. The supply chain data 380 may identify: cost data 381 identifying costs associated with a product and a shipping node in the supply chain network, including e.g. costs related to shipping, packaging, fulfilment and inventory levels of the product; order data 382 identifying data related to an order of a product from a customer, including e.g. features related to order placed time, upcoming events, quantity, price, and item indicators; and deliver data 383 identifying data about delivering products from a shipping node to a customer, including e.g. features related to distance, destination region, carriers, transport vehicles, and labor capacity.

The database 116 may also store machine learning model data 390 identifying and characterizing one or more models and related data for supply chain network modeling and performance prediction. For example, the machine learning model data 390 may include: a graph neural network 392, an edge regression model 394, an edge classification model 396, a localization model 397, and training data 398.

The graph neural network 392 may be used to model at least part of the supply chain operations and tasks. In some embodiments, a supply chain network is associated with a sequence of tasks connected in an end-to-end pipeline. The tasks may include e.g. demand forecast, transaction simulation, net quantity prediction, sourcing, delivery speed prediction, localized promise, etc. In some embodiments, the machine learning model data 390 includes one or more graph neural networks 392 each applied to a corresponding one of the tasks in the end-to-end pipeline. In some embodiments, the tasks in the pipeline are performed based on different models, including graph neural network(s) and any of the other models in the machine learning model data 390. An output of one model may be used as an input to the subsequent or succeeding model in the pipeline.

In some examples, the graph neural network 392 may be used to compute a demand forecast for a given product. The graph neural network 392 may be trained and tested based on daily graphs, each representing transactions within one day, where the product is represented as a node in the daily graphs. In addition, other products, customers, and shipping nodes (like stores and fulfillment centers) can be represented as nodes in the daily graphs as well. The daily graphs also include edges between nodes, where each edge represents transaction related data like features related to order, cost, or delivery. The graph neural network 392 can be trained based on historical daily graphs, which captures transaction data across different stores, different customers, and different products, to provide an accurate demand forecast. For example, an inventory level at a store for the product may impact the demand forecast for the product. A daily sales number of the product at the store may impact the inventory level. A daily sales number of a different product (which may be a competitor or alternative of the product) may impact the daily sales number of the product. A demand data or forecast for the different product may impact the daily sales number of the different product. These connections can go on and on, but they are all captured in the graph data of the daily graphs of the supply chain network.

The edge regression model 394 may be used to solve an edge regression problem for one of the tasks in the supply chain pipeline. In some examples, the edge regression model 394 may be used to compute a net quantity prediction or a delivery speed prediction, e.g. at an order line-item granularity. For example, the edge regression model 394 can be used to map the transaction features to the quantity purchased without including any look ahead or biased features. Based on historical purchase patterns of customers, a label can be predicted for an edge of (customer, orders, product). In some embodiments, the output of the edge regression model 394 can be filtered to only include the non-zero transactions to send it forward to the next task.

The edge classification model 396 may be used to solve an edge classification problem for one of the tasks in the supply chain pipeline. In some examples, the edge classification model 396 may be used to select a source node for delivering a product to a particular customer. In some examples, this is a binary edge classification problem where a 1 or 0 is predicted for valid and invalid edges respectively, based on optimality of the sourcing chosen. The objective is to choose the right fulfillment center to deliver the product to the particular customer. In some embodiments, the edge classification model 396 may be a binary classification model trained based on labelled positive and negative edges in daily graphs. After training, the edge classification model 396 can be used to compute a probability-based ranking score for one or more ideal shipping nodes to deliver the product to the customer.

The localization model 397 may be used to solve a localization problem for one of the tasks in the supply chain pipeline. In some examples, the localization model 397 may help to determine a speed to promise for a product delivery in a particular region based on delivery estimates. The localization model 397 can update a realistic estimate of delivery time to match customer expectation from that local region, by optimizing on delivery time. The updated delivery time estimate can be shown on the retailer's website or app, to a customer from that region or requesting a delivery to that region. In some embodiments, the delivery time estimate can be updated by using localized predictions, simulated forecasts and aggregating them by region, to be displayed to customers on the retailer's website.

The training data 398 may include data utilized for training one or more of the graph neural network 392, the edge regression model 394, the edge classification model 396, and the localization model 397. In some examples, the training data 398 may be formed based on: data related to a plurality of customers, their historical transaction data, user session data, data related to a plurality of products of a retailer, and data related to a supplier, a manufacturer, a distributor, or the retailer's store, warehouse, fulfillment center, distribution center, or consolidation center. For example, the training data 398 may include a graph dataset including a series of daily heterogenous graphs each representing transaction data in a day. In some examples, the same graph dataset may be used to train multiple machine learning models in the machine learning model data 390. In some examples, the training data 398 is updated based on updated transaction related data and/or updated supply chain data.

In some embodiments, the machine learning model data 390 includes any number of the graph neural network(s) 392, the edge regression model(s) 394, the edge classification model(s) 396, and the localization model(s) 397. A supply chain network may include an end-to-end pipeline of sequential tasks that are performed by any number of the graph neural network(s) 392, the edge regression model(s) 394, the edge classification model(s) 396, and the localization model(s) 397.

In some examples, the prediction data computing device 102 receives a query 310 from the server 104. The query 310 may be associated with a supply chain network of a retailer. In some embodiments, the prediction data computing device 102 may represent the supply chain network as at least one graph based on historical transactions and/or supply chain data in the supply chain network. Using at least one machine learning model in the machine learning model data 390, the prediction data computing device 102 can generate supply chain prediction data 312 based on the query 310. The supply chain prediction data 312 may indicate a prediction or estimate of the supply chain network's performance in response to a simulated change requested in the query 310. In response to the query 310, the prediction data computing device 102 transmits the supply chain prediction data 312 to the server 104.

In some embodiments, the prediction data computing device 102 may assign one or more of the above described operations to a different processing unit or virtual machine hosted by one or more processing devices 120. Further, the prediction data computing device 102 may obtain the outputs of the these assigned operations from the processing units, and generate the supply chain prediction data 312 based on the outputs.

In some embodiments, a disclosed system, e.g. the system in FIG. 3, provides an integration of graph-based modeling and neural network techniques to simulate supply chain operations and perform counterfactual simulations. This offers at least the following key technical advancements.

(1) Heterogeneous Graph Representation: Without overlooking the complex and interconnected nature of the supply chain network, the use of heterogenous graph neural networks allows for a more comprehensive representation of the supply chain, capturing diverse entities such as suppliers, manufacturers, distributors, products and customers, along with their relationships and dependencies. This enables a more accurate and realistic simulation of supply chain operations. A data pipeline is built to convert tabular transactions data into a heterogenous temporal graph data, that can be used to train multiple different models for sequential operations in the supply chain. The same underlying graph dataset functions as the foundation, that can be modified slightly and used to train multiple different GNN modules. These form the subcomponents of a digital twin of the supply chain network.

(2) Dynamic Modeling and Adaptability: Heterogenous graph neural networks offer the ability to capture the dynamic nature of the supply chain by allowing real-time updates and integration of data. The model can continuously incorporate new information, such as changes in demand, inventory levels, or disruptions, and dynamically adjust the simulations accordingly. This adaptability enables decision-makers to assess the impact of changing scenarios and make informed decisions based on up-to-date information.

(3) Data Centric: Neural networks, integrated within the graph neural network framework, can learn from historical supply chain data and patterns. By leveraging historical data, the model can identify correlations, patterns, and dependencies that may not be evident in traditional approaches. This data-centric approach enables the digital twin to generate insights and recommendations based on learned patterns, enhancing the accuracy and effectiveness of simulations. The graph neural networks can be used for prediction and inductive inference on unseen situations and modeling the dynamic nature (e.g. new nodes and edges) of the supply chain network.

(4) Counterfactual Simulations: The integration of heterogenous graph neural networks allows for the simulation of counterfactual scenarios, where variables and constraints can be manipulated to explore alternative courses of action. The supply chain network itself can be changed for some counterfactual scenarios as well. This capability empowers decision-makers to assess the impact of different strategies, changes in operational parameters, or potential disruptions without affecting real-world operations. It facilitates “what-if” analysis and helps in identifying optimal solutions and risk mitigation strategies. The digital twin allows for the comparison of different supply chain strategies, configurations, and operational parameters in a risk-free virtual environment. This framework is also a customizable gym environment that can be used to train reinforcement learning agents for co-operative supply chain game strategy.

(5) Deep Learning and Scaling Capabilities: This feature in the digital twin enables the model to capture complex patterns, perform advanced analytics, and make accurate predictions and handle extremely large amounts of data. Deep learning techniques can be used to optimize decision-making processes, identify anomalies, forecast demand, and enhance overall supply chain performance. The system creates a deep learning framework that ties in the inputs and outputs of multiple GNN models in sequence, while imposing business constraints and simulation inputs that feed into subsequent downstream tasks and perform joint optimization of the supply chain tasks and can scale regionally to the whole country.

(6) Benchmarking Performance: Measuring supply chain operation performance is a crucial aspect of managing and improving the efficiency and effectiveness of a supply chain. Using this digital twin of the supply chain and performing counterfactual simulations, the system can predict the order flow and delivery performance of the existing supply chain. In addition to predicting these, the system can identify the root causes of inefficiencies or poor performance within the supply chain.

In some embodiments, a supply chain network can be modeled as a graph. By analyzing historical sales data, customer behavior, and temporal market trends, a deep learning framework may be built to give a quick inference of the expected demand forecast for products, optimize for inventory levels, identify the delivery node and optimize the transportation and logistics of the immediate transactions. The system can model transactions as edges between different graph nodes like customers, products and shipping nodes and do binary classification for sourcing and edge regression for any prediction of a target label.

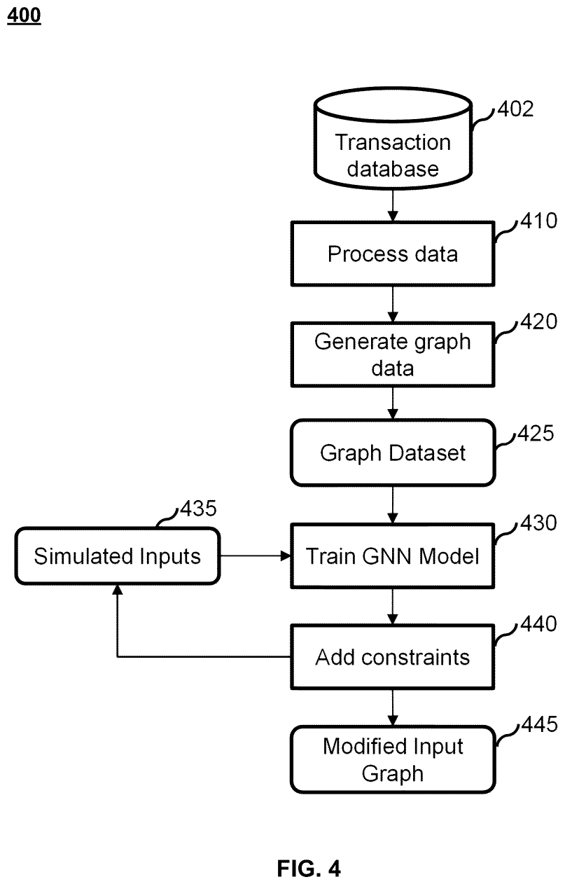

FIG. 4 illustrates an exemplary process 400 for modeling a supply chain network, in accordance with some embodiments of the present teaching. In some embodiments, the process 400 can be carried out by one or more computing devices, such as the prediction data computing device 102, and/or the cloud-based engine 121 of FIG. 1.

As shown in FIG. 4, the process 400 starts from operation 410, where transaction data is obtained and processed from a transaction database 402. The transaction database 402 may be a standalone database or part of the database 116. In some examples, the transaction database 402 stores millions of timestamped transactions in tables with several attributes related to the transactions. The relational tabular data of rows and columns in the transaction database 402 can be consumed to identify aspects of these transactions at the operation 410 and converted into graphs at the operation 420. In some embodiments, the conversion is performed by merging multiple data sources in database queries with filters that allow to shard the data regionally.

In some embodiments, during the graph creation at the operation 420, some features that are very node specific are aggregated across some time period, e.g. a whole year. These features are processed and stored as node features with an index-embedding lookup dictionary for mapping. The node features or attributes are used to differentiate and find similar nodes, to learn from and/or aggregate the features. The node features may be updated with current information through edge connections in the daily graph and the embeddings are refined. Attributes specific to transactions, that vary every day, like time-based attributes, cost, distance, transport vehicle, inventory level, etc., are modeled as edges between the three main nodes: customers, products, and shipping nodes. Each customer node represents a customer of a retailer. Each product node represents a product offered for sale by the retailer. Each shipping node represents a supplier, a manufacturer, a distributor, or the retailer's store, warehouse, fulfillment center, distribution center, or consolidation center.

Each edge in a graph is between two nodes and encapsulates a relation between the two nodes, source and destination, indicated in the edge_index. Each edge can also have features/attributes, one of which can be a supervised label for training a machine learning model, depending on what the objective is and which pattern is being learnt by the model.

The relationship between two nodes may be associated with transaction-related features. The edges may include order edges, cost edges and deliver edges. An order edge is between a customer node and a product node, and can be represented as (customer, orders, product). The order edge may be associated with features related to: order placed time, upcoming events, quantity, price, item indicators, etc. A cost edge is between a product node and a shipping node, and can be represented as (product, costs, shipnode). The cost edge may be associated with costs related to: shipping, packaging, fulfilment and inventory levels, etc. A deliver edge is between a shipping node and a customer node, and can be represented as (shipnode, delivers, customer). The deliver edge may be associated with features related to: distance, destination region (e.g. zip codes), carriers, transport vehicles, labor capacity, etc.

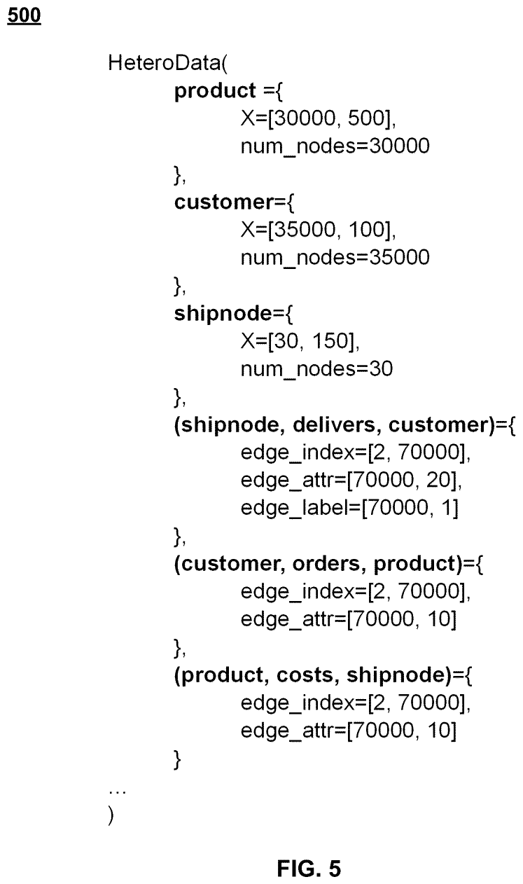

In some embodiments, the operation 420 generates a heterogenous graph for each day's transactions. FIG. 5 illustrates an exemplary daily heterogenous graph 500, in accordance with some embodiments of the present teaching. As shown in FIG. 5, the daily heterogenous graph 500 includes product nodes, customer nodes, shipping nodes, each with some features. In this example, the daily heterogenous graph 500 for a region includes 30000 products each with 500 product features, 35000 customers each with 100 customer features, and 30 shipping nodes each with 150 shipping node features. That is, the daily heterogenous graph 500 represents daily transactions performed by 35000 customers involving 30000 products shipped from 30 different shipping nodes.

As shown in FIG. 5, the daily heterogenous graph 500 further includes edges connecting the nodes based on their interactions. In this example, the daily heterogenous graph 500 includes 70000 deliver edges between shipping nodes and customer nodes, where each deliver edge has 20 features or attributes. In addition, the daily heterogenous graph 500 also includes 70000 order edges between customer nodes and product nodes, where each order edge has 10 features or attributes. Furthermore, the daily heterogenous graph 500 also includes 70000 cost edges between product nodes and shipping nodes, where each cost edge has 10 features or attributes.

In the example shown in FIG. 5, the deliver edges include an edge label that is associated with a parameter to be predicted, e.g. a delivery speed. The edge label may be used as a target for a GNN model to learn to predict the delivery speed. In other examples, the daily heterogenous graph 500 may include a different edge label in the (customer, orders, product) edge to indicate a net quantity. Then the different edge label may be used as a target for a different GNN model to learn to predict the net quantity.

In some embodiments, the daily heterogenous graph 500 may include additional data, e.g. other types of edges between the nodes, and time based information. While the daily heterogenous graph 500 represent transactions in one day, the system can create 365 graphs for an entire year's transactions, and connect them in time sequence.

Referring back to FIG. 4, at the operation 420, the system can save the created daily heterogenous graphs after applying transforms that make them undirected, normalized and have self-loops. The multiple daily graphs can be connected in sequence, over the time horizon of one or more years to create a graph dataset 425 including the temporal aspect of the graphs. In some embodiments, the graph dataset 425 may be split into weekly batches to train a GNN model at operation 430.

In some examples, the graph dataset 425 includes a set of 365 graphs from January till December. The graphs in January to August can be used as training data for the GNN model to learn prediction. The graphs in September to October can be used as validation data to understand whether the GNN model is learning correctly or not. The graphs in November to December can be used as test data to test the performance of the trained GNN model. In some examples, the scope of the data can be expanded to include multiple years for training. In some examples, data for training validation and testing are split in a 80%: 10%: 10% ratio.

In some embodiments, the dynamic nature of the graphs for the entire year, involving addition and removal of nodes or edges and prediction on new unseen nodes, can be simulated and estimated by the graph convolution operations. In some examples, the node embeddings pass through an auto encoder that refines the embeddings through message passing and allows for feature sharing. This gives the system an inductive benefit since sparse features are strengthened by similar nodes and connected neighbors.

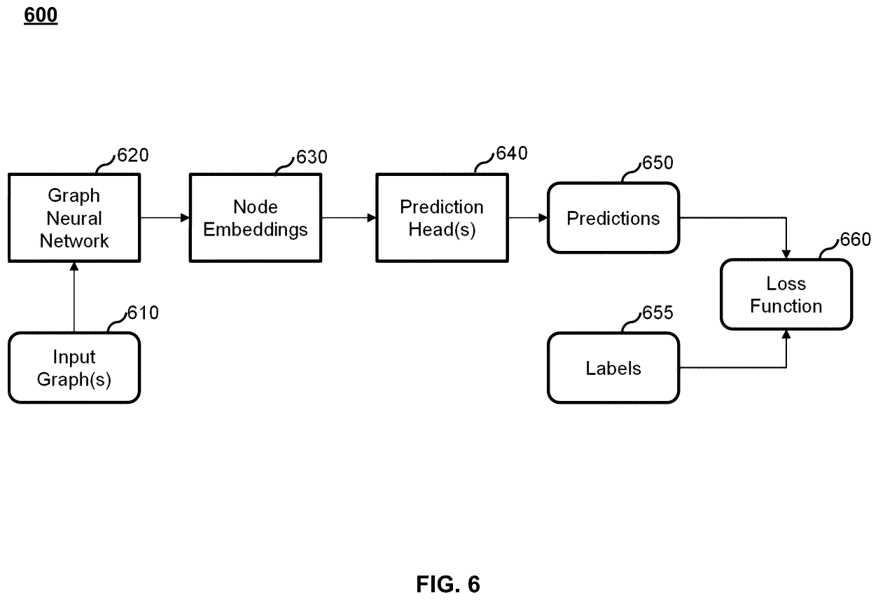

FIG. 6 illustrates an exemplary process 600 for training and optimizing a graph neural network, in accordance with some embodiments of the present teaching. In some embodiments, the process 600 can be carried out by one or more computing devices, such as the prediction data computing device 102, and/or the cloud-based engine 121 of FIG. 1. In some embodiments, the process 600 may be a detailed process of the operation 430 in FIG. 4.

As shown in FIG. 6, the process 600 starts from loading one or more subsets of input graphs 610 to a graph neural network for training the graph neural network at operation 620. At operation 630, a node embedding may be generated for each node in the input graphs using an auto-encoder. Some of the node embeddings in the input graphs may be refined through message passing.

At operation 640, all of the graph data, including node features, edge features, graph temporal data, and information across different graphs, may be used to generate predictions 650 based on one or more prediction heads. A prediction head may be a feed-forward layer in the graph neural network. In some embodiments, mean aggregation can be performed at the operation 640 based on the metadata of the graphs. In some embodiments, the predictions 650 may represent a prediction or classification task performed at node, edge or graph level by the one or more prediction heads.

In some embodiments, the system can obtain labels 655 from the input graphs 610. Each of the labels 655 may indicate a target for a corresponding prediction of the predictions 650. The target may be generated based on historical or simulation data. The system can compute a loss function 660 based on the differences between the predictions 650 and the labels 655. The loss function 660 may be pre-designed based on a corresponding task to be predicted or estimated in the supply chain network. In some embodiments, the loss function 660 may be used as a feedback for tuning the hyperparameters and/or weights in the operations 620, 630, 640 to generate updated predictions closer to the labels 655. After training the graph neural network with multiple iterations and multiple batches of input graphs 610, a graph neural network (GNN) model is generated and ready for inference in response to any query.

In some embodiments, different GNN models may be trained in a similar manner to the process 600 for different tasks. The labels 655 and the final objective for each task may be different and modified accordingly.

Referring back to FIG. 4, after training the GNN model at the operation 430, the system can trust the GNN model based on the validation and test processes. Then the system can try adding different constraints at operation 440. A constraint may reflect a hypothetical scenario, like what would happen if item A is removed from the inventory, what would happen if item B is at a different location, what would be the shipping speed if item C is shipped from a different shipping node, etc. These constraints may be added to test different scenarios of the supply chain network by creating simulated inputs 435. The simulated inputs 435 can be used to further train the GNN model at the operation 430, to determine inference based on the simulated inputs 435.

In some embodiments, after training and testing the GNN model with various what-if simulations, a modified input graph 445 is generated as an output of the trained GNN model. The modified input graph 445 may be used as an input to a second GNN model used for a next task in the supply chain network. For example, the trained GNN model in FIG. 4 may be used for a first task of predicting a transaction quantity in the supply chain network during a future time period. The second GNN model may be used for a second task (a subsequent or next task of the first task) of predicting delivery speed and/or routing optimization for delivering the products in the predicted transactions from the first task. In some embodiments, the prediction results of the second task can help to further re-train or tune the parameters of the model in the first task.

In some embodiments, the GNN models of a supply chain network are entirely data driven and their embeddings can be refined through message passing, limiting the need for manual feature engineering. The heterogenous GNNs offer a powerful solution by providing a flexible general-purpose framework to represent and process such complex data of a supply chain network of a big retailer. By modeling the supply chain as a graph, where entities are nodes and relationships are edges, GNNs enable efficient information propagation and reasoning. The GNN based predictions are inductive in nature, and interpretable, allowing the system to perform forecasting and quick inference of various supply chain tasks that are connected end to end. The output of one GNN model forms the input to the subsequent model. For example, it is imperative to solve some of the pressing issues in the supply chain like: demand forecasting, risk management, routing and scheduling operations, inventory management and anomaly detection. Because some tasks rely on the output of previous tasks, a graph based framework is built to employ several models (GNN and other models) to provide the right stimulus or input, for a sequential flow of conditional tasks or optimization objectives. Some modules are connected end-to-end, while others are auxiliary and solve for other issues based on the same graph dataset. Simulating these conditions using a disclosed end-to-end GNN framework for multiple ecommerce use-cases will: (1) mitigate problems in the strategic, tactical, and operational aspects of supply chain, (2) reduce likelihood of any disruption in service or customer dissatisfaction, and (3) optimize specific use-case models that can be reused as input-output modules.

In some embodiments, building an end-to-end framework or customizable environment around such a complex graph structure can help to simulate various scenarios to identify and assess risks in the supply chain. With multiple models trained on the same underlying graph datasets, a sequential end-to-end pipeline can be produced, where outputs of one model feed in as inputs to the next model, with added constraints and accounting for real time factors such as distance, inventory, timeline, etc. The information and insight can be used to reduce costs and improve customer service.

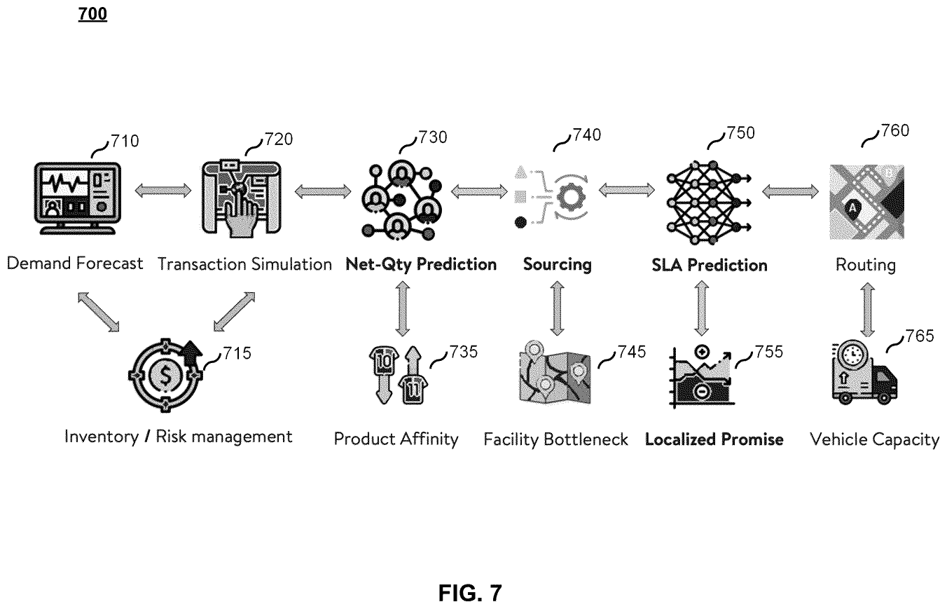

FIG. 7 illustrates an exemplary task pipeline 700 in a supply chain network, in accordance with some embodiments of the present teaching. This end-to-end task pipeline 700 includes a sequence of tasks including: demand forecast 710, transaction simulation 720, net-quantity prediction 730, sourcing 740, service level agreement (SLA) prediction 750 and routing 760. Each of these tasks may be performed based on a machine learning model. As such, a plurality of machine learning models can be connected in a model sequence to form an end-to-end simulation for the supply chain network. In some embodiments, all of the machine learning models in the model sequence are trained based on a same training dataset, which may be generated based on transaction data of the supply chain network like the graph dataset 425.

In some embodiments, an output of one model in the model sequence serves as an input to a succeeding model in the model sequence. For example, a model associated with the task of demand forecast 710 may generate an output to be used as an input to another model associated with the task of transaction simulation 720. In some embodiments, when a query is received regarding one model corresponding to one task in the task pipeline 700, the one model is run to provide the results in response to the query independently of other models. In some embodiments, after the query is received, in addition to the one model, other models corresponding to other tasks are also triggered because their outputs can impact the result of the one model. For example, when a query regarding demand forecast 710 is received, not only the model for demand forecast itself is run. Because a demand forecast for a product may depend on a net quantity sales for the product within a time period, which in turn depends on the choice of sourcing shipping nodes to ship the product, which in turn depends on the estimated delivery speed and promised delivery time for the product, which in turn depends on the optimal routing strategy and vehicle capacity for delivering the product, which may in turn depend on the optimal routing strategy and vehicle capacity for delivering other products, which may in turn depend on the estimated delivery speed and promised delivery time for other products, which may in turn depend on the choice of sourcing shipping nodes to ship the other products, which may in turn depend on a net quantity sales for the other products. This kinds of connections can go on and on for all models in the task pipeline 700.

As such, each model in the task pipeline 700 can be used separately or connected together. The training or optimization of one model could be dependent on or a prediction of the other models' performance. In some embodiments, a decision of a change in one module of the task pipeline 700 can automatically drive the changes in other modules of the task pipeline 700.

In some embodiments, a model in the task pipeline 700 can predict future data based on historical data. For example, a GNN model for the demand forecast 710 can predict demand for a product on the next day by creating a new daily graph based on the past multiple daily graphs e.g. the past 365 daily graphs. In some embodiments, a model in the task pipeline 700 can predict impact of a requested or simulated change in the supply chain network based on interactions between different aspects of the supply chain, as discussed above.

In some embodiments, the machine learning models in the model sequence include two GNNs generated based on two graphs respectively. The two graphs may be connected using at least one edge extending between nodes in the two graphs. The prediction data generated for a simulated supply chain operation based on a first GNN of the two GNNs may be used to optimize one or more parameters of a second GNN of the two GNNs. The simulated supply chain operation may be based on a query obtained from a user input or a feature that is pre-determined. In some embodiments, the models for the task pipeline 700 do not have to be all GNN models. In some embodiments, all of the models for the task pipeline 700 are GNN models.

As shown in FIG. 7, each task in the end-to-end task pipeline 700 may be associated with a query or feature. For example, the demand forecast 710 and the transaction simulation 720 are associated with a query or feature for inventory and risk management 715. The net-quantity prediction 730 may be associated with a query or feature for product affinity 735. The sourcing 740 may be associated with a query or feature for facility bottleneck 745. The SLA prediction 750 may be associated with a query or feature for localized promise 755. The routing 760 may be associated with a query or feature for vehicle capacity 765.

The end-to-end task pipeline 700 may be implemented for various flow scenarios. In some examples, given an expected demand forecast 710 per product for an upcoming month as an input, the system can cluster customers into profiles based on temporal occurrence and historic spending patterns from their refined embeddings.

In some examples, with the likelihood of a customer profile distribution being active on a particular day, the system can sample 75% of customer node embeddings from the clusters and generate 25% new embeddings by adding Gaussian noise. The system can either construct a simulated graph through the clusters or perform a graph generation via diffusion by the transaction simulation module 720. These may be done for the time horizon of one month with 30 daily graphs.

In some examples, edge combinations can be created between customers and products, in each day's graph, which goes as an input to the model of net-quantity prediction 730, giving an expected likely quantity of each product that each customer will purchase. In some embodiments, only non-zero transactions are considered, and the rest are filtered out. The modified graph with net-quantity prediction then forms an input for the sourcing module 740.

In some examples, based on who the customer is, when and how much of a product will be purchased, and what is the delivery speed promised to them while ordering, the system predicts an ideal source node that holds the product in the inventory and can ship it in the right amount of time by the sourcing module 740. This may be done by testing the validity of the edges between shipping nodes and a given customer node, and ranking them, e.g. through the probabilities, if there are multiple valid nodes.

In some examples, with the selection of the shipping nodes, the completed graphs are passed in sequence to the SLA prediction module 750, which checks current and previous states of the supply chain network and can accurately estimate the delivery times and days. Knowing the hourly delivery timings of different orders during the day will help in routing decisions at the routing module 760 to map a delivery journey including information about not only delivery locations but also expected timings for those delivery locations.

In some examples, once the route, orders and vehicles are finalized as input, the system may manage the capacity and filter some more orders. To maximize capacity, the system may propose to either move some deliveries to next day or prioritize some delayed deliveries on the current day, to fit them optimally. These proposals can be provided as insight data or prediction data to decision makers, or be used as instructions for down-stream systems to directly execute the corresponding operations.

The above described is an end-to-end flow from forecasted demand to customer delivery. In some embodiments, there are auxiliary and standalone models that can be used in conjunction. In some examples, given an estimate of delivery times and delays, the system can provide customers in a current region with an updated delivery speed for the product based on aggregates of delivery times for the upcoming month in that locality.

In some examples, if certain items are not available or have low inventory, the system can also simulate transactions with substitute items that are very similar or augment the basket of the simulated customer with high-affinity items with respect to the forecasted products. This will give more comprehensive and realistic cart/basket simulations.

In some examples, in line with the upcoming forecast and supply chain operations, the system can use the generated simulation inputs to perform a risk analysis and manage inventory in different shipping locations. In some examples, this whole process can be expanded to a longer time frame to gather and validate more simulation data, to spot network bottlenecks and/or to explore causal repercussions of opening a new facility in a required location.

In some embodiments, the net-quantity prediction 730 is associated with an edge regression problem at an order line-item granularity. The transaction features can be mapped to the quantity purchased without including any look ahead or biased features. Based on historical purchase patterns of customers, the system can predict the label for (customer, orders, product) edges. Some edges may also include labels 0 or −1 for returned items in the training data to allow the model to understand: customer affinity or similarity to each other, product affinity or similarity to each other, and customer-product affinity indicating a likelihood that a customer will purchase a product. In some embodiments, this model output can be filtered to only include the non-zero transactions to send it forward to the next task.

In some embodiments, the sourcing 740 is associated with a binary edge classification problem to predict a 1 or 0 for valid and invalid edges respectively, based on optimality of the sourcing chosen. The objective is to choose the right fulfillment center to deliver the product to a particular customer. In some examples, in each graph, 30% of edges are used for message passing and 70% of edges are labeled as positive edges and the same amount of negative edges are sampled, from each day's active shipping nodes and customer nodes. In some examples, an 80/10/10 split of these transactions is performed across all graphs for the entire year to train a binary classification model to identify and get a probability ranking score for ideal shipping nodes with inventory, to deliver the product to the customer.

In some embodiments, delivery speed prediction at the SLA prediction 750 is associated with an edge regression problem at an order line-item granularity. The objective is to predict how long it would take to deliver a product, from a chosen shipping node, e.g. a chosen fulfillment center, to a particular customer based on when the order was placed. In some examples, every transaction is associated with a delivery SLA time which is the number of hours it takes from the order placed time, to be delivered to the customer's provided address. This edge regression model adapts to real time attributes of the transactions and accounts for various factors like distance from the chosen source node for shipping. This can give a quick prediction of the number of days it takes to fulfill the order. This model output may be used to optimize routing and scheduling for transportation and logistics.

In some embodiments, speed-tier classification or localized promise is an ancillary stand-alone model to help making business decisions on what speed to promise for a product delivery in a particular region based on the delivery estimates. The system can update the speed badges of products, per region or zip code, by taking a weighted average of the predicted number of days it takes to deliver that product to customers in that area, in an upcoming future timeline. This can help updating the realistic estimate of delivery time on the retailer's website or app to match customer expectation and optimize for on time delivery.

In some embodiments, the models in the whole flow of the task pipeline 700 can be run on a graph dataset that has been filtered per region. For scalability reasons, the system can split the entire country into 10 regions, based on demographics, fulfillment center locations, inventory mirroring strategy and volume of transactions per day. In the example of United States, each region encompasses a collection of states. In some embodiments, the base for all the graphs for the regions is the same. A same time period of the transactions can be modified into different structures of graphs with changes to what the prediction label will be or which edge is used for regression based on the task.

In some examples, the models of the task pipeline 700 can be separately generated for each region based on a different dataset. Each model can be used to perform predictions for the corresponding region. To make some predictions at a national level, the models in all regions can be run to aggregate their results together. For example, a same SLA prediction model may be trained based on different datasets generated for different regions, to create different SLA prediction model versions with parameters and weights optimized for the corresponding regions, respectively.

In some embodiments, the supply chain operation and delivery performance can be measured by predicting the existing network's order flow, thanks to the predictive power of the inductive GNN modules, e.g. the modules 710˜760 in the task pipeline 700. In some embodiments, through these GNN modules in the digital twin framework, the system can leverage historical data and real-time inputs to predict order flow. By analyzing factors such as customer demand, inventory levels, lead times, transportation routes, and fulfillment center capabilities, the digital twin framework can simulate the movement of orders through the supply chain. This allows for the prediction of order fulfillment rates, order cycle times, and the identification of potential bottlenecks or delays.

In some embodiments, the GNN modules can provide prediction data at different levels of a graph, e.g. edge predictions, node predictions or node classifications, or predictions at the entire graph level.

In addition, the system can predict delivery performance metrics such as on-time delivery rates, delivery lead times, and delivery reliability. In some examples, the sourcing module 740 is essentially a network topology predictor giving the likelihood of each fulfillment center as an optimal source. In some examples, the speed tier classification coupled with optimal source can give network routing capabilities and manage or rate inventory levels. In some examples, the net quantity and delivery speed predictions, given the inventory and route, can show an order level performance of the current supply chain on future transactions. As such, the modules and models in the task pipeline 700 can impact each other and provide inputs, not only to the next or preceding module, but also to other modules depending on the relationships between different corresponding tasks. Accordingly, the training or optimization of one model may be based on training or optimization of another model in the same pipeline. According to a query, the system can use one of these models to generate a corresponding prediction, or use multiple or all of these models to generate prediction data. But a query regarding one task may trigger inference from both a model for this task and other models for other tasks in the supply chain pipeline, due to their interconnections as descried herein.

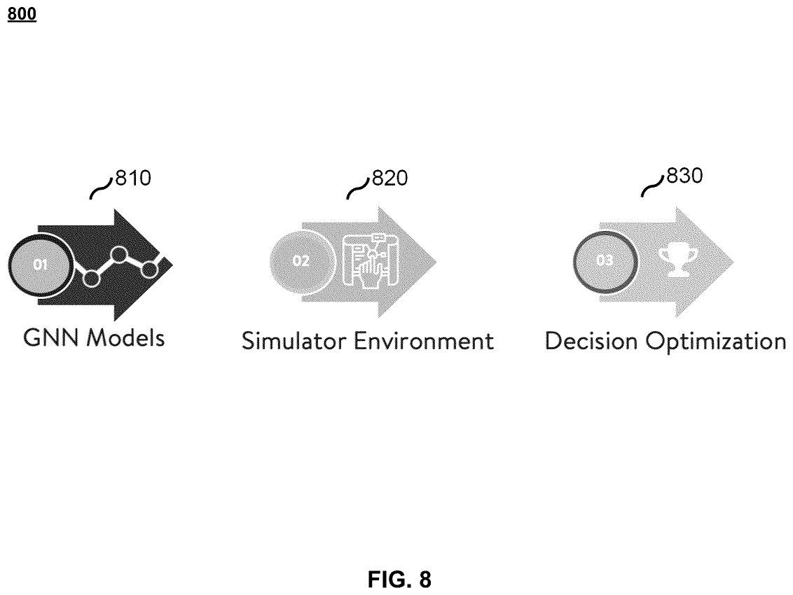

FIG. 8 illustrates an exemplary simulation framework 800 for a supply chain network, in accordance with some embodiments of the present teaching. In some embodiments, the simulation of inventory flow, through different supply chain operations modeled by GNNs along with standalone data driven business decision models that are derived from the same graph structure, forms the basis for the simulation framework 800. The multiple modules in the supply chain network (e.g. the modules 710˜760 in the task pipeline 700) can interact with each other by connecting outputs as inputs and also enable adding any constraints for integration or to toggle and modify the network structure for counterfactual scenarios by adding and deleting nodes or edges. A counterfactual scenario may refer to any scenario that is not expected or desired to happen in reality.

As shown in FIG. 8, the simulation framework 800 includes an operation 810 for building GNN models, an operation 820 for setting simulator environment, and an operation 830 for decision optimization. At the operation 810, various GNN models can be built for a supply chain network. In some examples, the models can be built for performing tasks like order forecast, demand sourcing, actual delivery time prediction, inventory, substitutes, fulfillment center location, delivery route optimization, vehicle capacity optimization, etc. In some examples, one or more models can be utilized to predict a daily regional demand of items from historical e-commerce sales per customer segment. In some examples, one or more models can be utilized to predict hourly differences from what was promised during purchase. In some examples, one or more models can be utilized to generate feedback to decide placement of new fulfillment center(s) and inventory to hold based on demographic data. In some examples, one or more models can be utilized to determine location and timing of orders to meet promised SLA, or perform cost optimization of the routes taken.

At the operation 820, the system can connect or integrate all models to generate a simulator environment for answering any what if query later during the decision optimization. In some embodiments, at the operation 820, the system can determine constraint modeling and rewards, perform module integration, and flow through active nodes. In some examples, the system can drive the decision behavior with penalties that restrict actions per domain heuristic. In some examples, the system can connect prediction models with expectation bounds to simulate inputs. In some examples, the system can determine the topology of a daily hierarchical graph for a given day with node and edge masking. The simulator environment generated at the operation 820 provides an indication of how the actual supply chain will behave, by showing how to flow inventory through these active nodes.

At the operation 830, the system can perform decision optimization based on e.g. end-to-end policy optimization and network evolution. In some examples, the system can learn optimal policy of sequential decisions through reinforcement learning methods. In some examples, the system can predict network performance in response to dynamic and temporal changes in the topology of the supply chain network, based on simulations.

A reinforcement learning agent or an automated agent may be trained during a simulation to perform different actions. Each of those actions will have a consequence triggering either a reward or a penalty. For a given task in the supply chain network, a reward will be given to the automated agent when an action of the agent moves the network close to a task goal of the task, and a penalty will be given to the automated agent when an action of the agent moves the network away from the task goal. The values for the reward and penalty can be predetermined based on separate simulation or modeling. In some examples, a reward function may be determined based on revenue, profit, cost, and/or delivery time. For example, a 10 point reward may be given to the agent if its action lowers the cost; and a −5 point penalty may be given to the agent if its action makes the delivery time longer.

In some embodiments, one agent is trained for each module in the task pipeline 700. In some embodiments, a same agent may be trained to simulate all models and modules in the supply chain network, e.g. the modules 710˜760 in the task pipeline 700. The agent can take sequential decisions, where a different set of actions is taken at different modules for different tasks. The agent can interact with the simulator environment multiple times. Based on a reward and penalty given for each action at each time, the agent is driven towards certain action manners that can maximize the total reward and/or minimize the total penalty, based on an objective of the task.

In some embodiments, based on a query, the system can determine a task in the supply chain network and a reward function associated with the task. The system can train an automated agent to learn a manner of performing simulated actions in a dynamic environment of the supply chain network. Each simulated action is assigned a reward value based on the reward function. The automated agent is trained based on a graph neural network to maximize a cumulative reward value based on the performed simulated actions. At least one simulated change of the supply chain network can be determined based on the query. The system can generate supply chain prediction data based on a simulation of the supply chain network using the graph neural network based on the at least one simulated change. The automated agent is configured to perform, during the simulation, simulated actions according to the learned manner based on modifications of the graph neural network in response to the at least one simulated change.

In some embodiments, the system can further determine, based on the simulation and the graph neural network, insight data of the supply chain prediction data; and transmit the supply chain prediction data together with the insight data in response to the query. The insight data includes at least one root cause of a performance of the supply chain network in response to the at least one simulated change.

In some embodiments, the choice of simulation approach depends on the specific objectives, complexity, and available data of the supply chain network. A combination of different simulation methods and models may be employed to address various aspects of supply chain operations effectively. In addition to digital twins, several alternative approaches to supply chain simulation may also be used. In some embodiments, a customized digital twin solution tailored to the specific needs of a retailer may be more suitable to incorporate the necessary scalability, integration capabilities, customization options, and decision-making complexities required to effectively model and simulate the retailer's extensive supply chain network.

In some embodiments, the digital twin considers various factors, including transportation schedules, order prioritization, fulfillment center capacities, and network efficiency. Through counterfactual simulations, different scenarios can be tested to identify optimal strategies for improving delivery performance and reducing the cost by choosing the right source. This enables decision-makers and the business to assess the effectiveness of alternative strategies, such as changing transportation modes, optimizing inventory levels, or modifying fulfillment center locations.

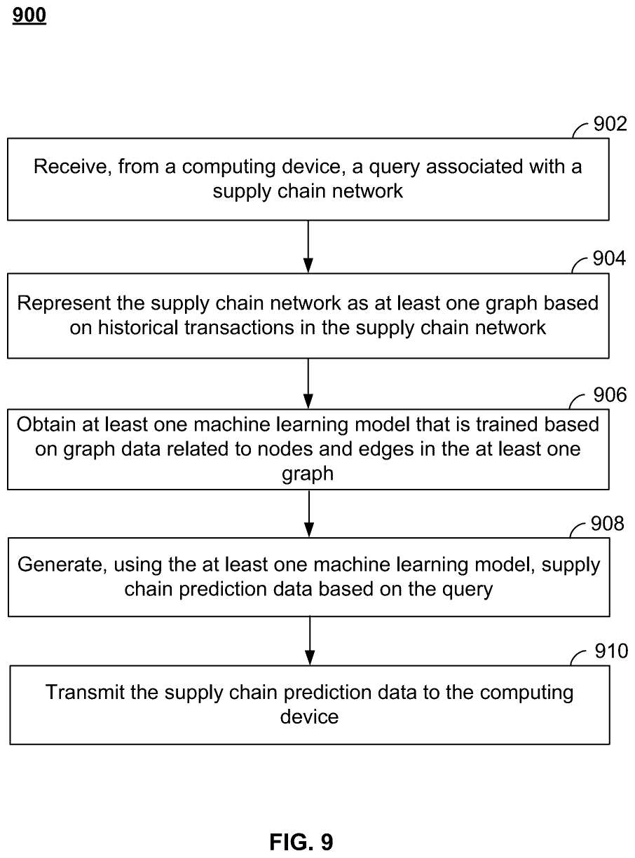

FIG. 9 is a flowchart illustrating an exemplary method 900 for supply chain network modeling and performance prediction, in accordance with some embodiments of the present teaching. In some embodiments, the method 900 can be carried out by one or more computing devices, such as the prediction data computing device 102 and/or the cloud-based engine 121 of FIG. 1. Beginning at operation 902, a query associated with a supply chain network is received from a computing device. At operation 904, the supply chain network is represented as at least one graph based on historical transactions in the supply chain network. At operation 906, at least one machine learning model is obtained, the at least one machine learning model being trained based on graph data related to nodes and edges in the at least one graph. At operation 908, using the at least one machine learning model, supply chain prediction data is generated based on the query. The supply chain prediction data is transmitted at operation 910 to the computing device.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
receive, from a computing device, a query associated with a supply chain network,
represent the supply chain network as at least one graph based on historical transactions in the supply chain network,
obtain at least one machine learning model that is trained based on graph data related to nodes and edges in the at least one graph,
generate, using the at least one machine learning model, supply chain prediction data based on the query, and
transmit the supply chain prediction data to the computing device.

2. The system of claim 1, wherein the nodes in the at least one graph comprise at least:
product nodes each representing a product offered for sale by a retailer;
customer nodes each representing a customer of the retailer; and
shipping nodes each representing a supplier, a manufacturer, a distributor, or the retailer's store, warehouse, fulfillment center, distribution center, or consolidation center.

3. The system of claim 2, wherein:
each edge in the at least one graph is between two nodes in the at least one graph, and represents a relationship between the two nodes;
the relationship is associated with transaction-related features; and
the edges in the at least one graph comprise at least:
an order edge between a customer node and a product node, wherein the order edge is associated with features related to at least: order placed time, upcoming events, quantity, price, and item indicators,
a cost edge between a product node and a shipping node, wherein the cost edge is associated with costs related to at least: shipping, packaging, fulfilment and inventory levels,
a deliver edge between a shipping node and a customer node, wherein the deliver edge is associated with features related to at least: distance, destination region, carriers, transport vehicles, and labor capacity.

4. The system of claim 1, wherein the supply chain network is represented as the at least one graph based on:
obtaining tabular data associated with the historical transactions in the supply chain network; and
converting the tabular data for the historical transactions in each day to a daily graph to create daily graphs over a time period.

5. The system of claim 4, wherein converting the tabular data for the historical transactions in each day to the daily graph comprises:
generating an embedding for each node in the daily graph using an auto-encoder; and
refining each embedding through message passing in the daily graph.

6. The system of claim 4, wherein the at least one machine learning model is trained based on:
generating a sequence of the daily graphs to create a graph dataset including temporal aspect of the sequence;
splitting the graph dataset into a plurality of batches to generate a training dataset; and
training the at least one machine learning model based on the training dataset.

7. The system of claim 6, wherein:
the at least one machine learning model includes a model sequence of machine learning models;
the machine learning models in the model sequence include at least one graph neural network (GNN);
each of the machine learning models in the model sequence is utilized to perform a corresponding task in the supply chain network;
all of the machine learning models in the model sequence are trained based on the same training dataset; and
an output of one machine learning model in the model sequence serves as an input to a succeeding machine learning model in the model sequence.

8. The system of claim 7, wherein:
the machine learning models in the model sequence include two GNNs generated based on two graphs respectively; and
the at least one processor is configured to:
connect the two graphs using at least one edge extending between nodes in the two graphs,
generate prediction data for a simulated supply chain operation based on a first GNN of the two GNNs, and
optimize one or more parameters of a second GNN of the two GNNs based on the prediction data.

9. The system of claim 1, wherein the supply chain prediction data is generated based on:
determining, based on the query, a task in the supply chain network and a reward function associated with the task;
training an automated agent to learn a manner of performing simulated actions in a dynamic environment of the supply chain network, wherein each simulated action is assigned a reward value based on the reward function, wherein the automated agent is trained based on a graph neural network in the at least one machine learning model to maximize a cumulative reward value based on the performed simulated actions;
determining at least one simulated change of the supply chain network based on the query; and
generating the supply chain prediction data based on a simulation of the supply chain network using the graph neural network based on the at least one simulated change, wherein the automated agent is configured to perform, during the simulation, simulated actions according to the learned manner based on modifications of the graph neural network in response to the at least one simulated change.

10. The system of claim 9, wherein the at least one processor is configured to:
determine, based on the simulation and the graph neural network, insight data of the supply chain prediction data, wherein the insight data includes at least one root cause of a performance of the supply chain network in response to the at least one simulated change; and
transmit the supply chain prediction data together with the insight data to the computing device.

11. A computer-implemented method, comprising:
receiving, from a computing device, a query associated with a supply chain network;
representing the supply chain network as at least one graph based on historical transactions in the supply chain network;
obtaining at least one machine learning model that is trained based on graph data related to nodes and edges in the at least one graph;
generating, using the at least one machine learning model, supply chain prediction data based on the query; and
transmitting the supply chain prediction data to the computing device.

12. The computer-implemented method of claim 11, wherein the nodes in the at least one graph comprise at least:
product nodes each representing a product offered for sale by a retailer;
customer nodes each representing a customer of the retailer; and
shipping nodes each representing a supplier, a manufacturer, a distributor, or the retailer's store, warehouse, fulfillment center, distribution center, or consolidation center.

13. The computer-implemented method of claim 12, wherein:
each edge in the at least one graph is between two nodes in the at least one graph, and represents a relationship between the two nodes;
the relationship is associated with transaction-related features; and
the edges in the at least one graph comprise at least:
an order edge between a customer node and a product node, wherein the order edge is associated with features related to at least: order placed time, upcoming events, quantity, price, and item indicators,
a cost edge between a product node and a shipping node, wherein the cost edge is associated with costs related to at least: shipping, packaging, fulfilment and inventory levels,
a deliver edge between a shipping node and a customer node, wherein the deliver edge is associated with features related to at least: distance, destination region, carriers, transport vehicles, and labor capacity.

14. The computer-implemented method of claim 11, wherein representing the supply chain network as the at least one graph comprises:
obtaining tabular data associated with the historical transactions in the supply chain network; and
converting the tabular data for the historical transactions in each day to a daily graph to create daily graphs over a time period.

15. The computer-implemented method of claim 14, wherein converting the tabular data for the historical transactions in each day to the daily graph comprises:
generating an embedding for each node in the daily graph using an auto-encoder; and
refining each embedding through message passing in the daily graph.

16. The computer-implemented method of claim 14, wherein the at least one machine learning model is trained based on:
generating a sequence of the daily graphs to create a graph dataset including temporal aspect of the sequence;
splitting the graph dataset into a plurality of batches to generate a training dataset; and
training the at least one machine learning model based on the training dataset.

17. The computer-implemented method of claim 16, wherein:
the at least one machine learning model includes a model sequence of machine learning models;
the machine learning models in the model sequence include at least one graph neural network (GNN);
each of the machine learning models in the model sequence is utilized to perform a corresponding task in the supply chain network;
all of the machine learning models in the model sequence are trained based on the same training dataset; and
an output of one machine learning model in the model sequence serves as an input to a succeeding machine learning model in the model sequence.

18. The computer-implemented method of claim 17, further comprising:
connecting two graphs using at least one edge extending between nodes in the two graphs, wherein the machine learning models in the model sequence include two GNNs generated based on the two graphs respectively;
generating prediction data for a simulated supply chain operation based on a first GNN of the two GNNs; and
optimizing one or more parameters of a second GNN of the two GNNs based on the prediction data.

19. The computer-implemented method of claim 11, wherein generating the supply chain prediction data comprises:
determining, based on the query, a task in the supply chain network and a reward function associated with the task;
training an automated agent to learn a manner of performing simulated actions in a dynamic environment of the supply chain network, wherein each simulated action is assigned a reward value based on the reward function, wherein the automated agent is trained based on a graph neural network in the at least one machine learning model to maximize a cumulative reward value based on the performed simulated actions;
determining at least one simulated change of the supply chain network based on the query; and
generating the supply chain prediction data based on a simulation of the supply chain network using the graph neural network based on the at least one simulated change, wherein the automated agent is configured to perform, during the simulation, simulated actions according to the learned manner based on modifications of the graph neural network in response to the at least one simulated change.

20. A non-transitory computer readable medium having instructions stored thereon, wherein the instructions, when executed by at least one processor, cause at least one device to perform operations comprising:
receiving, from a computing device, a query associated with a supply chain network;
representing the supply chain network as at least one graph based on historical transactions in the supply chain network;
obtaining at least one machine learning model that is trained based on graph data related to nodes and edges in the at least one graph;
generating, using the at least one machine learning model, supply chain prediction data based on the query; and
transmitting the supply chain prediction data to the computing device.
